(19) United States
(12) Patent Application Publication
(10) Pub. No.: US 2014/0143966 A1
(43) Pub. Date: May 29, 2014

(54) PRE-PACKAGED CLEANING SYSTEM FOR CYLINDERS OF PRINTING MACHINES

(71) Applicant: Pavan Forniture Grafiche S.P.A., Verona (IT)

(72) Inventor: LUCA PAVAN, VILLAFRANCA (IT)

(73) Assignee: PAVAN FORNITURE GRAFICHE S.P.A., Verona (IT)

(21) Appl. No.: 14/085,471

(22) Filed: Nov. 20, 2013

(30) Foreign Application Priority Data
Nov. 23, 2012 (IT) VR2012A000232

(51) Int. Cl. B41F 35/00

(52) U.S. Cl. CPC B41F 35/00
USPC 15/104.93

(57) ABSTRACT

Described is a pre-packaged cleaning system for cylinders of printing machines (1), comprising at least one roll (2) of fabric pre-impregnated with solvent and designed for being associated with at least one cylinder of a printing machine and a wrapper (3) wound around the roll. The wrapper (3) comprises at least one supporting layer (4) and at least one layer (5) impermeable to the solvent and superposed on the supporting layer (4).

This invention relates to a pre-packaged cleaning system for cylinders of printing machines. More specifically, the system is suitable for cleaning rubber-coated sheets, also known as blankets, of offset printing machines. In the offset printing machines currently in use, there is the automatic washing of the metallic printing cylinders and of the rubber-coated sheet-carrying cylinders, the latter also known, in technical jargon, as “blankets”. More specifically, there are prior art system which make use of a fabric pre-impregnated with suitable solvent. More specifically, the pre-impregnated fabric is wrapped in a roll having predetermined dimensions and length.

Consequently, in the prior art there are bags for packaging these rolls. Disadvantageously, it has been found that the prior art bags are not able to keep the bags isolated from outside environment. More specifically, the solvent with which the rolls of fabric are impregnated tends to permeate through the bag, deform it, make it fragile and in particular cases escape, even if the bag has been hermetically sealed. This problem is more serious the more aggressive the solvents used are. For example, the most commonly used plastic materials of the polyester or polypropylene type, even high-density ones, have proved to be not perfectly impermeable and structurally resistant to the action of the solvents normally used, especially the more technical ones.

In this context, the technical purpose which forms the basis of this invention is to propose a pre-packaged cleaning system for cylinders of printing machines which overcomes the above mentioned disadvantages of the prior art.

More specifically, the aim of this invention is to provide a pre-packaged cleaning system for cylinders of printing machines which is able to guarantee the integrity and permanence of the impregnation during all the steps prior to the use, that is to say, storage, transport and when in stock, up to the installation in the printing machine.

The technical purpose indicated and the aims specified are substantially achieved by a pre-packaged cleaning system for cylinders of printing machines comprising the technical features described in one or more of the appended claims.

Further features and advantages of this invention are more apparent from the non-limiting description which follows of a preferred, non-limiting embodiment of a bag for packaging articles as illustrated in the accompanying drawings, in which:

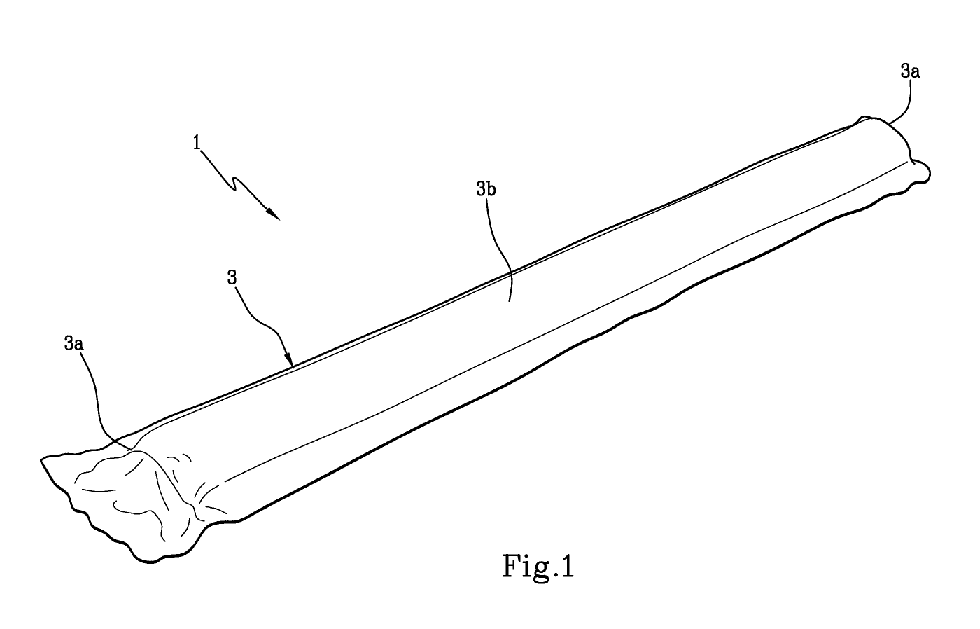

FIG. 1 is a perspective view of a first embodiment of a pre-packaged cleaning system for cylinders of printing machines according to this invention;

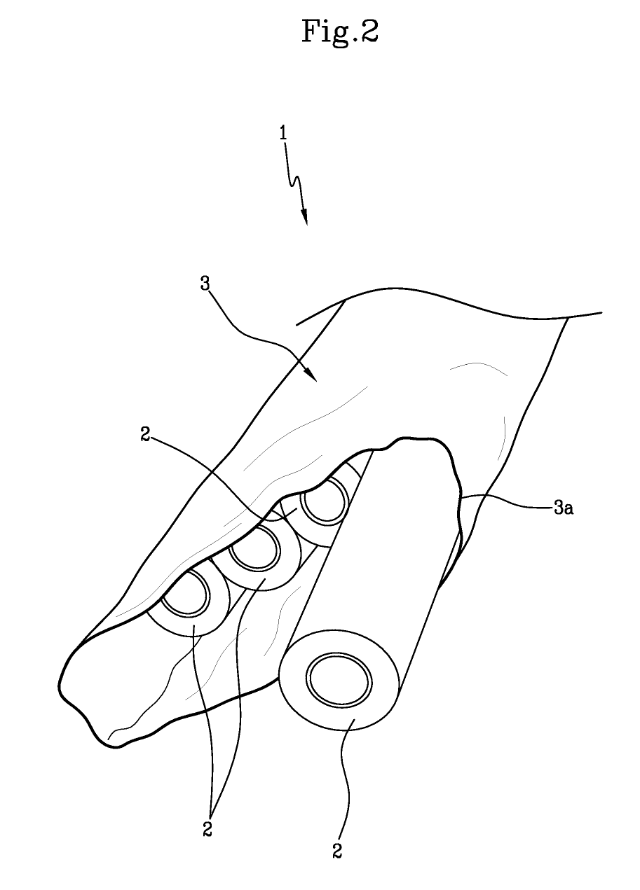

FIG. 2 is a perspective view of a second embodiment of a pre-packaged cleaning system for cylinders of printing machines according to this invention;

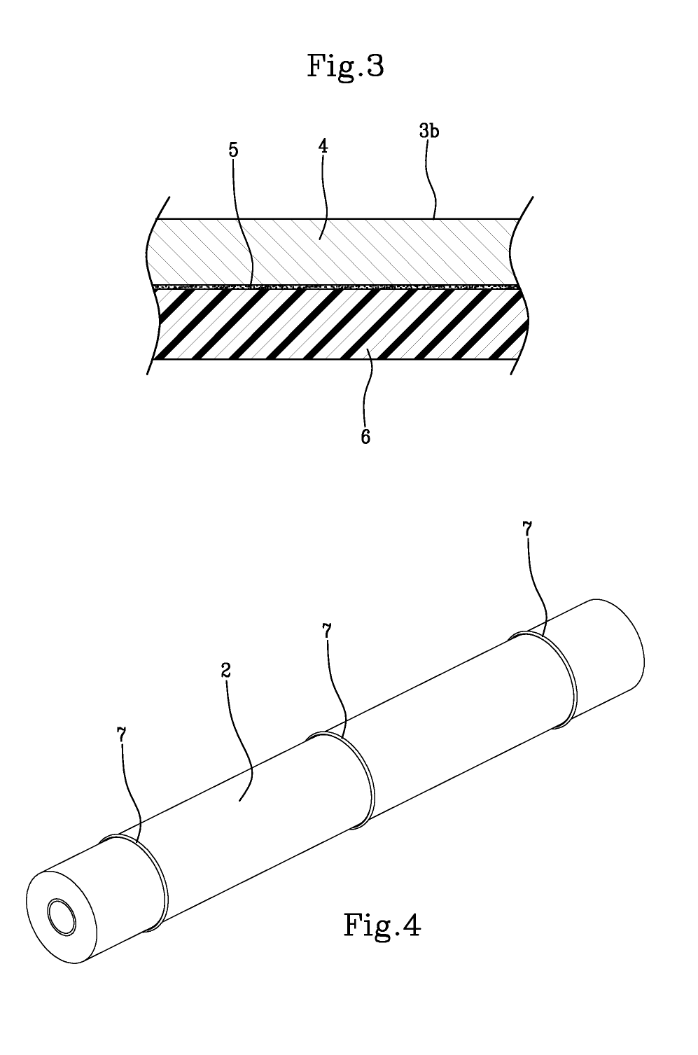

FIG. 3 is a schematic cross section of a detail of the system of FIGS. 1 and 2; and

FIG. 4 is a perspective view of a roll 2 of pre-impregnated fabric of the system of FIGS. 1 and 2.

With reference to the accompanying drawings, numeral 1 denotes a pre-packaged cleaning system for cylinders of printing machines comprising rolls 2 of fabric pre-impregnated with solvent. The rolls 2 are also designed for being associated with at least one cylinder of an offset printing machine.

The impregnating solvents used in the rolls 2 are compounds with the technical viscosity necessary for the stability of impregnation and release from the impregnated fabric, thus guaranteeing the maximum degree of cleaning of the inks. It should be noted that the solvent can be a Newtonian or non-Newtonian fluid. Preferably, the solvent is a Newtonian type, more specifically distillates of combined petroleum.

The pre-packaged cleaning system for cylinders of printing machines comprises in particular a wrapper 3, in particular of a multi-layer type, which has the purpose of completely wrapping the above-mentioned roll 2.

More in detail, the wrapper 3 forms a bag.

Preferably, the wrapper 3 is of a flexible type, and has a tubular shape. More specifically, the wrapper 3 has a pair of ends 3a. At least one of the ends 3a is closed. In detail, when the wrapper 3 is empty, in a step prior to the packaging of the roll 2, one of the ends 3a is closed, whilst the end 3a opposite to it is open to allow the roll 2 to be inserted. In an alternative embodiment, the wrapper 3a initially has both the ends 3a open. The ends 3a are then closed during packaging of the roll 2, according to a method described below.

It should be noted that the wrapper 3 is designed to receive the roll 2, that is to say, it has a shape and dimensions such that it is easy to insert the roll 2 inside the bag formed by the wrapper.

As shown, by way of example in FIG. 1, in a first embodiment the wrapper 3 is designed to receive a single roll 2. Preferably, the wrapper 3 is prepared in a tubular shape of various sizes, to house rolls made in a series of diameters of between 40 millimetres and 90 millimetres, which are able to cover the currently known dimensions. In any event, the wrapper 3 can be prepared in sizes suitable to house rolls of any dimension, that is to say, of any diameter and length.

As shown in FIG. 2, in a second embodiment the wrapper 3 is designed to receive five rolls 2, positioned parallel to each other. In that case, the dimensions of the wrapper 3 will be substantially equal to five times the dimensions of the wrapper for a single roll.

Alternative embodiments, non illustrated, are obviously possible wherein there can be any number of rolls 2 with any mutual arrangement, depending on the operating requirements.

In detail, the wrapper 3 comprises at least one supporting layer 4. The supporting layer 4 forms an outer surface 3b of the wrapper 3. In other words, amongst all the layers which make up the multi-layer wrapper 3, the supporting layer 4 is the one positioned outermost relative to the area in which the above-mentioned roll 2 is inserted. Preferably, the supporting layer 4 is made of PET. Preferably, the supporting layer 4 has a micrometric thickness of between 8 microns and 50 microns, even more preferably equal to 12 microns.

It should be noted that the outer surface 3b of the wrapper 3 is designed for being printed, in such a way as to make markings and/or decorations on the wrapper.

The wrapper 3 also comprises a layer 5 which is impermeable to a solvent. The impermeable layer 5 superposes the supporting layer 4. Preferably, the impermeable layer 5 has a micrometric thickness, that is, between 5 microns and 25 microns, even more preferably equal to 8 microns.

The impermeable layer 5 is in particular made from metallic material, and even more preferably from aluminium. Advantageously, this means that the wrapper 3 cannot be crossed by the atmospheric oxygen and it is resistant to the contact with the solvent. Still more advantageously, the presence of the metallic impermeable layer prevents any type of escape of solvent.

The wrapper 3 also comprises a heat sealable layer 6 associated with the impermeable layer 5. More specifically, the heat sealable layer is deposited from the opposite side of the impermeable layer 5 relative to the supporting layer 4. In other words, the impermeable layer 5 is between the heat sealable layer 6 and the supporting layer 4. Preferably, the heat sealable layer 6 is made of polyethylene. Preferably, the heat sealable layer 6 has a micrometric thickness of between 10 microns and 80 microns, even more preferably equal to 55 microns.

Advantageously, in this way the wrapper 3 can be closed by heat sealing. More specifically, with reference to the embodiment shown in FIG. 1, a continuous wrapper 3 is prepared having a diameter greater than the diameter of the 2 to be contained. The roll 2 is then inserted inside the wrapper 3 and the ends 3a are closed, heating them in such a way as to soften the heat sealable layer 6 up to a complete adhesion of the flaps of the wrapper 3 at the ends 3a. A similar method can also be used for the wrapper 3 shown in FIG. 2, but the size of the wrapper 3 will change as a function of the number and the dimensions of the rolls 2 to be packaged. In both the embodiments, the packaging of the roll 2 may occur according to two different methods, that is to say, under atmospheric pressure or vacuum sealed.

In detail, under atmospheric pressure, a micro-atmosphere will remain inside the wrapper 3 together with the roll 2. As the wrapper 3 is closed with a watertight seal, the presence of this micro-atmosphere will keep stable the impregnation of the fibres of the fabric, preventing the migration of the solvent inside the wrapper 3. In this manner, elastic rings 7 are positioned on the roll 2 to close it and prevent the release of the rolling tension once it has been placed inside the wrapper 3.

In an alternative, more preferable, method, the wrapper 3 can be vacuum sealed. In this case, the elastic rings 7 are superfluous as the rolling tension will be guaranteed by the wrapper 3. Moreover, advantageously, the wrapper 3 in close contact with the roll 2 guarantees the stability of impregnation. This type of packaging of the rolls 2 prevents the possible occurrence of opposite and uncontrollable molecular forces, which could modify the equilibrium of the impregnation. Advantageously, this vacuum sealed method of packaging allows the storage of the packaged roll 2 with any orientation relative to the horizontal plane.

It should also be noted that the impregnation of the roll 2 without saturation of the fibres of the fabric, combined with the predetermined viscosity of the impregnating solvent, creates a force resisting the natural tendency of levelling of the solvent. This phenomena makes the impregnation stable and homogeneous, and therefore able to keep itself firmly in equilibrium as it is protected by the wrapper 3 described above. This invention solves the above-mentioned technical problem. The presence of the metallic impermeable layer prevents any type of escape of solvent.

The invention also offers an important advantage. The impermeable layer prevents any interaction between the solvent and the atmospheric oxygen, stabilising the chemical composition and the physical properties, especially the viscosity.

1. A pre-packaged cleaning system for cylinders of printing machines (1), comprising:
at least one roll (2) of fabric pre-impregnated with solvent and designed for being associated with at least one cylinder of a printing machine;
a wrapper (3) wound around said at least one roll, characterised in that the wrapper (3) comprises:
a supporting layer (4);
a layer (5) impermeable to the solvent, said impermeable layer (5) being made of metallic material and superposed on the supporting layer (4);
a heat sealable layer (6) associated with the impermeable layer (5), said impermeable layer (5) being arranged between the heat sealable layer (6) and the supporting layer (4).

2. The pre-packaged cleaning system (1) according to claim 1, characterised in that the wrapper (3) has an outer surface (3b); the supporting layer (4) forming the outer surface (3b).

3. The pre-packaged cleaning system (1) according to claim 2, characterised in that the outer surface (3b) is printable.

4. The pre-packaged cleaning system (1) according to claim 1, characterised in that the heat sealable layer (6) is made of polyethylene.

5. The pre-packaged cleaning system (1) according to claim 1, characterised in that the wrapper (3) has a tubular shape and is substantially vacuum sealed about said at least one roll (2).

6. The pre-packaged cleaning system (1) according to claim 1, characterised in that the wrapper (3) is made of aluminium.
